(19) United States
(12) Patent Application Publication
(10) Pub. No.: US 2017/0311602 A1
(43) Pub. Date: Nov. 2, 2017

(54) METHODS AND COMPOSITIONS FOR THE CONTROL OF FUNGAL PATHOGENS IN CROP PLANTS

(71) Applicants: Monsanto Technology LLC, St. Louis, MO (US); Bayer CropScience LP, Research Triangle Park, NC (US)

(72) Inventors: Stefan Dutzmann, Langenfeld (DE); Frank Kohn, St. Louis, MO (US); Sally Metz, St. Louis, MO (US); Jennifer Riggs, Raleigh, NC (US); Anne Suty-Heinze, Langenfeld (DE)

(73) Assignees: Monsanto Technology LLC, St. Louis, MO (US); Bayer CropScience LP, Research Triangle Park, NC (US)

(21) Appl. No.: 15/528,346

(22) PCT Filed: Nov. 26, 2014
(86) PCT No.: PCT/US14/67584

§ 371 Date: May 19, 2017

(51) Int. Cl. A01N 43/88; A01N 43/653

(52) U.S. Cl. CPC A01N 43/88; A01N 43/653

(57) ABSTRACT

Provided herein are compositions and methods that are useful for the control of fungal pathogens in crop plants by reducing the incidence of corn stalk, ear and root rots and other diseases and for improving one or more agronomic characteristics of plants. The methods include administration of prothioconazole and/or fluoxastrobin to a plant, a seed, or soil.

### FIELD

Provided herein are compositions and methods that are useful for the control of fungal pathogens in crop plants by reducing the incidence of corn stalk, ear and root rots and other diseases, increasing yield and for improving one or more agronomic characteristics of plants.

### BACKGROUND

Control of plant diseases is crucial to the reliable production of food. Unfortunately, crop plants are susceptible to a wide variety of disease conditions caused by bacteria, fungi, or other factors. Corn plants, in particular, are susceptible to a class of fungal diseases one of which is known as stalk rot, which is detrimental to the growth of the corn plants and can significantly affect harvest yields. Losses from stalks rots may vary depending on season and region, but yield losses of 10-20 percent can occur on susceptible hybrids and losses of 50 percent have been reported in localized areas. Common stalk rots include Gibberella stalk rot Anthracnose stalk rot, Fusarium stalk rot, Diplodia ear or stalk rot and Macrophomina stalk rot, among others.

There is an urgent need in the industry for effective, economical, and environmentally safe methods to improve crop protection, yield and agronomic characteristics (including plant stand, crop safety, stalk lodging and vigor) of crop plants that are susceptible to diseases caused by fungal pathogens, including corn stalk, ear and root rots.

### SUMMARY

One aspect of the present disclosure is directed to a method of controlling stalk rot in corn. The method comprises administering prothioconazole and fluoxastrobin to one or more corn seeds, wherein the application rate of prothioconazole is at least about 10 grams a.i. per 100 kilograms of seed, and wherein the application rate of fluoxastrobin is at least about 10 grams a.i. per 100 kilograms of seed.

In another aspect of the present disclosure, a method of controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn is provided. The method comprises administering prothioconazole and fluoxastrobin to one or more corn seeds, wherein the application rate of prothioconazole is at least about 10 grams a.i. per 100 kilograms of seed, and wherein the application rate of fluoxastrobin is at least about 10 grams a.i. per 100 kilograms of seed.

In a further aspect of the present disclosure, a method of improving one or more agronomic characteristics of corn selected from the group consisting of plant stand, crop safety, stalk lodging and plant vigor is provided. The method comprises administering prothioconazole and fluoxastrobin to one or more corn seeds, wherein the application rate of prothioconazole is at least about 10 grams a.i. per 100 kilograms of seed, and wherein the application rate of fluoxastrobin is at least about 10 grams a.i. per 100 kilograms of seed.

Another aspect of the present disclosure is directed to a method of improving yield comprising administering prothioconazole to one or more corn seeds, wherein the application rate of prothioconazole is at least about 10 grams a.i. per 100 kilograms of seed.

Another aspect of the present disclosure is directed to a method of improving yield comprising administering fluoxastrobin to one or more corn seeds, wherein the application rate of fluoxastrobin is at least about 10 grams a.i. per 100 kilograms of seed.

Another aspect of the present disclosure is directed to a method of improving yield of corn plants. The method comprises administering fluoxastrobin and prothiconazole to one or more corn seeds, wherein the application rate of prothioconazole is at least about 10 grams a.i. per 100 kilograms of seed; and wherein the application rate of fluoxastrobin is at least about 10 grams a.i. per 100 kilograms of seed.

Further aspects of the present disclosure are directed to a method of (i) controlling stalk rot in corn, (ii) controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, (iii) improving one or more agronomic characteristics of corn selected from the group consisting of plant stand, crop safety, stalk lodging and plant vigor or (iv) improving yield. The method comprises administering prothioconazole and fluoxastrobin to soil surrounding a corn seed, or to soil surrounding the root zone of a corn plant, wherein the application rate of prothioconazole is at least about 50 grams a.i. per acre, and wherein the application rate of fluoxastrobin is at least about 50 grams a.i. per acre.

Another aspect of the present disclosure is directed to a treated corn seed comprising prothioconazole and fluoxastrobin, wherein the seed comprises prothioconazole in a concentration of at least about 10 grams a.i. per 100 kilograms of seed, and wherein the seed comprises fluoxastrobin is a concentration of at least about 10 grams a.i. per 100 kilograms of seed.

A still further aspect of the present disclosure is directed to a composition for (i) controlling stalk rot in corn, (ii) controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, (iii) improving one or more agronomic characteristics of corn selected from the group consisting of plant stand, crop safety, stalk lodging and plant vigor or (iv) improving yield, the composition comprising prothioconazole and fluoxastrobin, wherein the application rate of prothioconazole is at least about 10 grams a.i. per 100 kilograms of seed, and wherein the application rate of fluoxastrobin is at least about 10 grams a.i. per 100 kilograms of seed.

Other objects and features will be in part apparent and in part pointed out hereinafter.

### DETAILED DESCRIPTION

Generally, the compositions and methods described herein can be applied to seeds, plants, or the locus of plants wherein the control of fungal pathogens is desirable.

One aspect of the present disclosure is directed to a method of administering prothioconazole

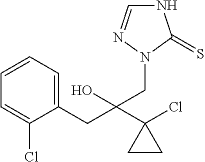 [SMILES: OC(Cc1ccccc1Cl)(Cn1nc[nH]c1=S)C1(Cl)CC1]

and fluoxastrobin

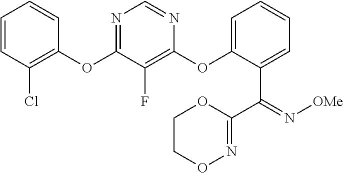 [SMILES: CO/N=C(/C1=NOCCO1)c1ccccc1Oc1ncnc(Oc2ccccc2Cl)c1F]

to a plant, a seed, or soil.

In one embodiment, the methods herein can be used for treating a corn seed, plant, or soil surrounding the corn plant. The corn plant may be a transgenic corn plant and/or the seeds thereof having one or more traits including but not limited to herbicide tolerance (e.g. glyphosate tolerant, auxin tolerant, HPPD tolerant, glufosinate tolerant, PPO tolerant), drought tolerance, insect tolerance, disease tolerance, stress tolerance and/or enhanced yield. In some embodiments the corn plant is enhanced with respect to certain traits, including disease, insect and herbicide tolerance, through conventional breeding. In another embodiment the corn seed comprises a transgenic and breeding trait as described herein.

For example, in one aspect, the present disclosure is directed to a method of administering prothioconazole and fluoxastrobin to a corn seed.

In another aspect, the present disclosure is directed to a method of administering prothioconazole and fluoxastrobin to soil surrounding a corn seed, or to soil surrounding the root zone of a corn plant.

In a further aspect, the present disclosure is directed to a method of administering prothioconazole and fluoxastrobin to a corn plant as a foliar application.

Typically, the prothioconazole and the fluoxastrobin are administered in a weight ratio of from about 3:1 to about 1:3. For example, the prothioconazole and the fluoxastrobin may be administered in a weight ratio of from about 2:1 to about 1:2, in a weight ratio of from about 1.5:1 to about 1:1.5, or in a weight ratio of about 1:1.

For example, in one aspect, the method comprises administering a treatment composition comprising prothioconazole and fluoxastrobin, wherein the treatment composition comprises prothioconazole and fluoxastrobin in a weight ratio of from about 3:1 to about 1:3.

In another aspect, the methods described herein may also improve one or more agronomic characteristics of plants and/or yield by controlling or reducing the incidence of disease caused by one or more fungal pathogens. In some embodiments, the disease is for example, Sclerotinia stalk rot, Anthracnose stalk rot, Diplodia ear or stalk rot, Fusarium stalk and ear rot, Gibberella stalk and ear rot, Macrophomina stalk rot, Marasmiellus stalk and root rot, Physoderma brown spot, and Harpophora late wilt. In some embodiments, Sclerotinia stalk rot is caused by Sclerotinia sclerotiorum, Sclerotinia libertiani, Anthracnose stalk rot is caused by Colletotrichum graminicola, Diplodia ear or stalk rot is caused by Diplodia maydis, Stenocarpella maydis, Fusarium stalk and ear rot is caused by Fusarium moniliforme, F. verticilliodes, Gibberella stalk and ear rot is caused by Giberella zeae, G. saubinetti, Fusarium roseum f sp. Cerealis, F. roseum graminearum, F. graminearum, Macrophomina stalk rot is caused by Macrophomina phaseolina, Marasmiellus stalk and root rot is caused by Marasmiellus spp., Physoderma brown spot is caused by Physoderma maydis, and Harpophora late wilt is caused by Harpophora maydis.

Non-limiting examples of agronomic characteristics that may be improved include yield, plant stand, crop safety, stalk lodging and plant vigor. Plant stand refers to the number of plants emerged at a specified time. Plant vigor is a measure of plant growth or foliage volume through time after planting. Crop safety is a measurement of the detrimental impact on a seed caused by various factors including crop protection agents. Yield (also known as “agricultural output”) refers to either the measure of the amount of a crop harvested per unit area of land cultivation or the seed generation of the plant itself

The methods described herein are particularly useful, for example, for the control of Anthracnose stalk rot caused by Colletotrichum graminicola in corn plants.

### Application to Seeds

One aspect of the disclosure is generally related to a method of protecting a seed, and/or the roots of a plant or plant parts grown from the seed, against damage caused by a fungal pathogen.

For example, in one aspect, the method comprises administering prothioconazole to a seed, wherein the application rate of prothioconazole is at least about 10 grams a.i. per 100 kilograms of seed or at least about 15, 30, 45, 60, 75, or 90 grams a.i. per 100 kilograms of seed. The method may comprise administering prothioconazole at an application rate of from about 30 to about 90, from about 45 to about 75, or from about 50 to about 60 grams a.i. per 100 kilograms of seed.

In another aspect, the method comprises administering fluoxastrobin to a seed, wherein the application rate of fluoxastrobin is at least about 10 grams a.i. per 100 kilograms of seed or at least about 15, 30, 45, 60, 75, or 90 grams a.i. per 100 kilograms of seed. The method may comprise administering fluoxastrobin at an application rate of from about 30 to about 90, from about 45 to about 75, or from about 50 to about 60 grams a.i. per 100 kilograms of seed.

In a further aspect, the method comprises administering prothioconazole and fluoxastrobin to a seed, wherein the prothioconazole and the fluoxastrobin are administered in a weight ratio of from about 3:1 to about 1:3. The prothioconazole and the fluoxastrobin may be administered to the seeds in a weight ratio of from about 2:1 to about 1:2, in a weight ratio of from about 1.5:1 to about 1:1.5, or in a weight ratio of about 1:1.

The method may comprise administering prothioconazole and fluoxastrobin in a combined application rate of at least about 20, 30, 60, 90, 120, 150, or 180 grams a.i. per 100 kilograms of seed. The method may comprise administering prothioconazole and fluoxastrobin in a combined application rate of from about 20 to about 180, from about 30 to about 180, from about 60 to about 180, from about 90 to about 150, or from about 110 to about 130 grams a.i. per 100 kilograms of seed.

The method may comprise the following combinations of loading rates for both active ingredients on seeds:

| Loading of Corn Seeds | Loading of Corn Seeds |
|---|---|
| with prothioconazole | with fluoxastrobin in |
| in g/100 kg of seeds | g/100 kg of seeds |
| 10 to 90 | 10 to 90 |
| 20 to 75 | 20 to 75 |
| 30 to 60 | 30 to 60 |
| 30 to 75 | 30 to 75 |
| 30 to 90 | 30 to 90 |
| 20 to 45 | 20 to 45 |
| 20 to 60 | 20 to 60 |
| 30 to 45 | 20 to 45 |
| 45 to 60 | 45 to 60 |
| 20 to 150 | 20 to 150 |
| 20 to 120 | 20 to 120 |

The seed treatment methods described herein can be used in connection with any species of plant and/or the seeds thereof. The methods are used in connection with corn seeds that are agronomically important. The seed may be a transgenic seed from which a transgenic plant can grow and incorporates a transgenic event that confers, for example, tolerance to a particular herbicide or combination of herbicides, increased disease resistance, enhanced tolerance to insects, drought, stress and/or enhanced yield. The seed may comprise a breeding trait, including for example, in one embodiment a disease tolerant breeding trait. In another embodiment, the corn seed includes at least one transgenic and breeding trait.

The seed treatment method may comprise applying a seed treatment composition to a seed prior to sowing the seed, so that the sowing operation is simplified. In this manner, seeds can be treated, for example, at a central location and then distributed for planting. This may permit a person who plants the seeds to avoid the complexity and effort associated with handling and applying the seed treatment compositions, and to merely plant the treated seeds in a manner that is conventional for regular untreated seeds.

The seed treatment composition can be applied to seeds by any standard seed treatment methodology, including but not limited to mixing in a container (e.g., a bottle or bag), mechanical application, tumbling, spraying, immersion, and solid matrix priming. Seed coating methods and apparatus for their application are disclosed in, for example, U.S. Pat. Nos. 5,918,413, 5,891,246, 5,554,445, 5,389,399, 5,107,787, 5,080,925, 4,759,945 and 4,465,017, among others. Any conventional active or inert material can be used for contacting seeds with the seed treatment composition, such as conventional film-coating materials including but not limited to water-based film coating materials.

For example, the seed treatment composition can be introduced onto or into a seed by use of solid matrix priming. For example, a quantity of the seed treatment composition can be mixed with a solid matrix material and then the seed can be placed into contact with the solid matrix material for a period to allow the seed treatment composition to be introduced to the seed. The seed can then optionally be separated from the solid matrix material and stored or used, or the mixture of solid matrix material plus seed can be stored or planted directly. Non-limiting examples of solid matrix materials which are useful include polyacrylamide, starch, clay, silica, alumina, soil, sand, polyurea, polyacrylate, or any other material capable of absorbing or adsorbing the seed treatment composition for a time and releasing the fungicide(s) of the seed treatment composition into or onto the seed. It is useful to make sure that the fungicide(s) and the solid matrix material are compatible with each other. For example, the solid matrix material should be chosen so that it can release the fungicide(s) at a reasonable rate, for example over a period of minutes, hours, days, or weeks.

Imbibition is another method of treating seed with the seed treatment composition. For example, a plant seed can be directly immersed for a period of time in the seed treatment composition. During the period that the seed is immersed, the seed takes up, or imbibes, a portion of the seed treatment composition. Optionally, the mixture of plant seed and the seed treatment composition can be agitated, for example by shaking, rolling, tumbling, or other means. After imbibition, the seed can be separated from the seed treatment composition and optionally dried, for example by patting or air drying.

The seed treatment composition may be applied to the seeds using conventional coating techniques and machines, such as fluidized bed techniques, the roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are generally known in the art.

If the seed treatment composition is applied to the seed in the form of a coating, the seeds can be coated using a variety of methods known in the art. For example, the coating process can comprise spraying the seed treatment composition onto the seed while agitating the seed in an appropriate piece of equipment such as a tumbler or a pan granulator.

When coating seed on a large scale (for example a commercial scale), the seed coating may be applied using a continuous process. Typically, seed is introduced into the treatment equipment (such as a tumbler, a mixer, or a pan granulator) either by weight or by flow rate. The amount of treatment composition that is introduced into the treatment equipment can vary depending on the seed weight to be coated, surface area of the seed, the concentration of the fungicide(s) and/or other active ingredients in the treatment composition, the desired concentration on the finished seed, and the like. The treatment composition can be applied to the seed by a variety of means, for example by a spray nozzle or revolving disc. The amount of liquid may be determined by the assay of the formulation and the required rate of active ingredient necessary for efficacy. As the seed falls into the treatment equipment the seed can be treated (for example by misting or spraying with the seed treatment composition) and passed through the treater under continual movement/tumbling where it can be coated evenly and dried before storage or use.

Alternatively, the seed coating may be applied using a batch process. For example, a known weight of seeds can be introduced into the treatment equipment (such as a tumbler, a mixer, or a pan granulator). A known volume of seed treatment composition can be introduced into the treatment equipment at a rate that allows the seed treatment composition to be applied evenly over the seeds. During the application, the seed can be mixed, for example by spinning or tumbling. The seed can optionally be dried or partially dried during the tumbling operation. After complete coating, the treated sample can be removed to an area for further drying or additional processing, use, or storage.

In a further alternative embodiment, the seed coating may be applied using a semi-batch process that incorporates features from each of the batch process and continuous process embodiments set forth above.

Seeds can be coated in laboratory size commercial treatment equipment such as a tumbler, a mixer, or a pan granulator by introducing a known weight of seeds in the treater, adding the desired amount of seed treatment composition, tumbling or spinning the seed and placing it on a tray to thoroughly dry.

Seeds can also be coated by placing the known amount of seed into a narrow neck bottle or receptacle with a lid. While tumbling, the desired amount of seed treatment composition can be added to the receptacle. The seed is tumbled until it is coated with the treatment composition. After coating, the seed can optionally be dried, for example on a tray.

The treated seeds may also be enveloped with a film overcoating to protect the fungicidal coating. Such overcoatings are known in the art and may be applied using conventional fluidized bed and drum film coating techniques. The overcoatings may be applied to seeds that have been treated with any of the seed treatment techniques described above, including but not limited to solid matrix priming, imbibition, coating, and spraying, or by any other seed treatment technique known in the art.

Application to Plants and/or Soil

Another aspect of the disclosure is generally related to protecting a plant and/or a seed against damage by a fungal pathogen. For example, in one aspect, a treatment composition comprising fluoxastrobin and/or prothioconazole is supplied to a plant and/or a seed exogenously. Typically, the treatment composition is applied to the plant, the seed, and/or the surrounding soil through sprays, drips, and/or other forms of liquid application.

In one aspect, a treatment composition comprising fluoxastrobin and/or prothioconazole is directly applied to soil surrounding a seed, or to soil surrounding the root zone of a plant.

For example, in one aspect, the method comprises applying prothioconazole and fluoxastrobin to soil surrounding a corn seed, or to soil surrounding the root zone of a corn plant, wherein the application rate of prothioconazole is at least about 50, 60, 70, 80 or 90 grams a.i. per acre, and wherein the application rate of fluoxastrobin is at least about 50, 60, 70, 80 or 90 grams a.i. per acre. For example, the application rate of prothioconazole can be from about 50 to about 100 grams a.i. per acre. and the application rate of fluoxastrobin is from about 50 to about 100 grams a.i. per acre.

The application may be performed using any method or apparatus known in the art, including but not limited to hand sprayer, mechanical sprinkler, or irrigation, including drip irrigation.

For example, the treatment composition may be applied to plants and/or soil using a drip irrigation technique. Preferably, the treatment composition is applied directly to the base of the plants or the soil immediately adjacent to the plants. The composition may be applied through existing drip irrigation systems. This procedure is particularly preferred for use in connection with cotton, strawberries, tomatoes, potatoes, vegetables, and ornamental plants.

In another example, the treatment composition may be applied to plants and/or soil using a drench application. Preferably, a sufficient quantity of the treatment composition is applied such that it drains through the soil to the root area of the plants. The drench application technique is particularly preferred for use in connection with turf grasses and crop plants, including corn.

In some embodiments, the composition is applied to soil after planting. In other embodiments, however, the composition may be applied to soil during planting. In other embodiments, however, the composition may be applied to soil before planting. When the composition is applied directly to the soil, it may be applied using any method known in the art. For example, it may be tilled into the soil or applied in furrow.

### Seed, Plant, or Soil Treatment Compositions

Another embodiment of the disclosure is generally related to a treatment composition comprising fluoxastrobin and/or prothioconazole as described herein for use in accordance with the methods or for preparation of the treated seeds described herein.

In some embodiments, the treatment composition may be an aqueous composition.

Generally, the treatment compositions described herein can comprise any adjuvants, excipients, or other desirable components known in the art. For example, in some embodiments, the treatment composition further comprises a surfactant.

Examples of anionic surfactants include alkyl sulfates, alcohol sulfates, alcohol ether sulfates, alpha olefin sulfonates, alkylaryl ether sulfates, arylsulfonates, alkylsulfonates, alkylaryl sulfonates, sulfosuccinates, mono- or diphosphate esters of polyalkoxylated alkyl alcohols or alkyl phenols, mono- or disulfosuccinate esters of alcohols or polyalkoxylated alkanols, alcohol ether carboxylates, phenol ether carboxylates. In one embodiment, the surfactant is an alkylaryl sulfonate.

Non-limiting examples of commercially available anionic surfactants include sodium dodecylsulfate (Na-DS, SDS), MORWET D-425 (a sodium salt of alkyl naphthalene sulfonate condensate, available from Akzo Nobel), MORWET D-500 (a sodium salt of alkyl naphthalene sulfonate condensate with a block copolymer, available from Akzo Nobel), sodium dodecylbenzene sulfonic acid (Na-DBSA) (available from Aldrich), diphenyloxide disulfonate, naphthalene formaldehyde condensate, DOWFAX (available from Dow), dihexylsulfosuccinate, and dioctylsulfosuccinate, alkyl naphthalene sulfonate condensates, and salts thereof.

Examples of non-ionic surfactants include sorbitan esters, ethoxylated sorbitan esters, alkoxylated alkylphenols, alkoxylated alcohols, block copolymer ethers, and lanolin derivatives. In accordance with one embodiment, the surfactant comprises an alkylether block copolymer.

Non-limiting examples of commercially available non-ionic surfactants include SPAN 20, SPAN 40, SPAN 80, SPAN 65, and SPAN 85 (available from Aldrich); TWEEN 20, TWEEN 40, TWEEN 60, TWEEN 80, and TWEEN 85 (available from Aldrich); IGEPAL CA-210, IGEPAL CA-520, IGEPAL CA-720, IGEPAL CO-210, IGEPAL CO-520, IGEPAL CO-630, IGEPAL CO-720, IGEPAL CO-890, and IGEPAL DM-970 (available from Aldrich); Triton X-100 (available from Aldrich); BRIJ S10, BRIJ S20, BRIJ 30, BRIJ 52, BRIJ 56, BRIJ 58, BRIJ 72, BRIJ 76, BRIJ 78, BRIJ 92V, BRIJ 97, and BRIJ 98 (available from Aldrich); PLURONIC L-31, PLURONIC L-35, PLURONIC L-61, PLURONIC L-81, PLURONIC L-64, PLURONIC L-121, PLURONIC 10R5, PLURONIC 17R4, and PLURONIC 31R1 (available from Aldrich); Atlas G-5000 and Atlas G-5002L (available from Croda); ATLOX 4912 and ATLOX 4912-SF (available from Croda); and SOLUPLUS (available from BASF), LANEXOL AWS (available from Croda).

Non-limiting examples of cationic surfactants include mono alkyl quaternary amine, fatty acid amide surfactants, amidoamine, imidazoline, and polymeric cationic surfactants.

In some embodiments, the treatment composition comprises a co-solvent in addition to water. Non-limiting examples of co-solvents that can be used include ethyl lactate, methyl soyate/ethyl lactate co-solvent blends (e.g., STEPOSOL, available from Stepan), isopropanol, acetone, 1,2-propanediol, n-alkylpyrrolidones (e.g., the AGSOLEX series, available from ISP), a petroleum based-oil (e.g., AROMATIC series and SOLVESSO series available from Exxon Mobil), isoparaffinic fluids (e.g. ISOPAR series, available from Exxon Mobil), cycloparaffinic fluids (e.g. NAPPAR 6, available from Exxon Mobil), mineral spirits (e.g. VARSOL series available from Exxon Mobil), and mineral oils (e.g., paraffin oil).

Examples of commercially available organic solvents include pentadecane, ISOPAR M, ISOPAR V, and ISOPAR L (available from Exxon Mobil).

In some embodiments, the treatment composition of fluoxastrobin and/or prothioconazole may be formulated, mixed in a seed treater tank, combined on the seed by overcoating, or combined with one or more additional active ingredients. The additional active ingredients may comprise, for example, a pesticide or a biological agent. In some embodiments, the treatment composition comprises comprise fluoxastrobin and/or prothioconazole and another pesticide, for example a nematicide, insecticide, fungicide, and/or herbicide. In some embodiments, the treatment composition comprises comprise fluoxastrobin and/or prothioconazole and a biological agent.

Non-limiting examples of insecticides and nematicides include carbamates, diamides, macrocyclic lactones, neonicotinoids, organophosphates, phenylpyrazoles, pyrethrins, spinosyns, synthetic pyrethroids, tetronic and tetramic acids. In another embodiment, insecticides and nematicides include abamectin, aldicarb, aldoxycarb, bifenthrin, carbofuran, chlorantraniliprole, clothianidin, cyantraniliprole, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, tioxazafen, nitenpyram, oxamyl, permethrin, spinetoram, spinosad, spirodichlofen, spirotetramat, tefluthrin, thiacloprid, thiamethoxam, and thiodicarb.

In one embodiment, the insectide may be selected from the group consisting of clothianidin, thiamethoxam, tioxazafen, imidacloprid and combinations thereof.

Non-limiting examples of useful fungicides include aromatic hydrocarbons, benzimidazoles, benzothiadiazole, carboxamides, carboxylic acid amides, morpholines, phenylamides, phosphonates, quinone outside inhibitors (e.g. strobilurins), thiazolidines, thiophanates, thiophene carboxamides, and triazoles, Non-limiting examples of fungicides include acibenzolar-S-methyl, azoxystrobin, benalaxyl, bixafen, boscalid, carbendazim, chlorothalonil, cyproconazole, dimethomorph, epoxiconazole, fludioxonil, fluopyram, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, pyraclostrobin, sedaxane, silthiofam, tebuconazole, thifluzamide, thiophanate, tolclofos-methyl, trifloxystrobin, and triticonazole.

In one embodiment, the fungicide may be selected from the group consisting of ipconazole, metalaxyl, trifloxystrobin, pyraclostrobin, fluxapyroxad, sedaxane, fluopyram, mefenoxam, penflufen, azoxystrobin and combinations thereof.

Non-limiting examples of herbicides include ACCase inhibitors, acetanilides, AHAS inhibitors, carotenoid biosynthesis inhibitors, EPSPS inhibitors, glutamine synthetase inhibitors, PPO inhibitors, PS II inhibitors, and synthetic auxins. Non-limiting examples of herbicides include acetochlor, clethodim, dicamba, flumioxazin, fomesafen, glyphosate, glufosinate, mesotrione, quizalofop, saflufenacil, sulcotrione, 2,4-D, trifloxysulfuron, and halosulfuron.

In one embodiment, the herbicide may be selected from the group consisting of acetochlor, dicamba, glyphosate and combinations thereof.

Additional actives may also comprise substances such as, biological agents for pest control, microbial extracts, plant growth activators or plant defense agents. Non-limiting examples of biological agents include bacteria, fungi, beneficial nematodes, and viruses.

In certain embodiments, the biological agent can be a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comamonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobia, Serratia, Sphingobacterium, Stenotrophomonas, Variovorax, and Xenorhabdus. In particular embodiments the bacteria is selected from the group consisting of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium suttsuga, Pasteuria penetrans, Pasteuria usage, and Pseudomonas fluorescens.

In certain embodiments the biological agent can be a fungus of the genus Alternaria, Ampelomyces, Aspergillus, Aureobasidium, Beauveria, Colletotrichum, Coniothyrium, Gliocladium, Metarhizium, Muscodor, Paecilomyces, Bradyrhizobia, Trichoderma, Typhula, Ulocladium, and Verticillium. In another embodiment the fungus is Beauveria bassiana, Coniothyrium minitans, Gliocladium vixens, Muscodor albus, Paecilomyces lilacinus, or Trichoderma polysporum.

In further embodiments the biological agents can be plant growth activators or plant defense agents including, but not limited to harpin, Reynoutria sachalinensis, jasmonate, lipochitooligosaccharides, salicylic acid and isoflavones. In another embodiment, the biological agent may be selected from the group consisting of Bacillus firmus.

Having described the embodiments in detail, it will be apparent that modifications and variations of the disclosure are possible without departing from the scope of the appended claims.

### EXAMPLES

The following non-limiting examples are provided for further illustration.

### Example 1

Seeds treated with chemistry were evaluated for seed safety in greenhouse emergence trials. Seed treatment active ingredients were combined in a slurry mix with colorant, polymer, and water at the recommended rates and allowed to mix thoroughly. Using a Gustafson BMC lab treater the seed batch was deposited in the BMC coater and treatment slurry was injected and allowed to tumble for 35-40 seconds before being ejected into a bulk collection bin and transferred to a paper storage bag. Standard corn stalk rot susceptible hybrids were planted using six pot replicates of five plants per pot. The treatments were randomized in RCBD, blocked by GH watering trays. Planting media consisted of 3.5 inch pots with the following media: US10 soil and 50/50 mix of US10/REDIEARTH. Replicates were placed perpendicular to the greenhouse temperature gradient.

Initial daily emergence counts at spike emergence of first treatment, continued until emergence was complete in untreated control (7-10 days after planting). The final stand was calculated as the number of plants emerged at day 7. The stand AUC was calculated as the area under the emergence curve.

TABLE 1
Seedling Emergence with Seed Treatment

| | Rate | | |
|---|---|---|---|
| Treatment | g ai/100 kg seed | Final Stand | Stand AUC |
| Fluoxastrobin | 25 | 4.79 | 10.2 |
| | 50 | 4.67 | 9.9 |
| | 100 | 4.63 | 8.9 |
| | 200 | 4.83 | 9.6 |
| | 300 | 4.58 | 8.3 |
| | 400 | 4.99 | 9.9 |
| Prothioconazole | 25 | 4.88 | 10.4 |
| | 50 | 4.75 | 9.6 |
| | 100 | 4.58 | 9.3 |
| | 200 | 4.92 | 10.2 |
| Polymer Control | NA | 4.8 | 11.4 |
| Untreated | NA | 4.92 | 12.2 |

### Example 2

Field trials were conducted to evaluate seed treatments for efficacy and yield. Field plots contained a single row or up to 4 rows by 20-40 feet. Smallest plot size was a single row by 20 feet. Four replications were typically used. The hybrids selected for the study were typically moderately susceptible to Anthracnose stalk rot, which indicates a susceptibility rating of at least 5-6 on a 9 point scale (1=highly resistant, 9=highly susceptible). Yield plots had a minimum of two rows.

The typical growth stage for field inoculation was VT/R1 (tasseling/silking). For disease ratings, stalks were surface wounded using implements with needles that either provided shallow scratches on the surface of the stalk (˜1 cm depth) or shallow piercing wounds (˜1 cm depth). Concurrent with surface wounding, a spore suspension of Colletotrichum graminicola (C. graminicola) conidia is sprayed onto wounded area or injected into shallow wounds. The total volume of spore suspension applied was in the range of 1-5 mL. Yield trials were soil inoculated or non-inoculated (natural pressure). For soil inoculation the fungus was grown on sorghum seed and the infested sorghum seed was placed in furrow at planting of the trials.

Disease development was monitored in control treatments and disease evaluations were usually targeted when disease index rating reached approximately 5 on a 1-9 scale in control treatments. If disease development in control plots was less than 5, evaluations were typically conducted no later than the R6 growth stage.

10 stalks were assessed per plot. No barren plants or plants next to gaps were chosen. The stalks were cut at ear node (node at base of ear) and the leaves were removed from the cut stalks. The stalks were split and the number of internodes with disease symptoms was counted starting at the internode above top node with brace roots (disease incidence rating). The typical maximum number of internodes in the section of stalk was 5, but occasionally was as high at 6. Only the bottom 5 internodes were included in the incidence count.

The severity rating was determined by counting the number of same internodes with >50% of the internode showing necrosis. The summed disease index value (1-9) is calculated by adding the rating values from the incidence rating plus the values from the >50% severity rating. For example, if the disease incidence rating was 3 and the >50% severity rating was 2 then the summed disease index value would be 5. Although the sum of the disease incidence rating and the severity rating could result in a total disease index value of greater than 9, 9 was the maximum disease index value recorded.

TABLE 2
Disease Severity Ratings with Seed Treatment

| | Rate of PRO or | Disease Severity |
|---|---|---|
| | FLUOX g ai/100 kg | (nodes ≧50% |
| Treatment* | seed | necrosis) |
| Control (surface wounding) | NA | 2.9 |
| Prothioconazole (PRO) | 60 | 1.6 |
| Fluoxastrobin (FLUOX) | 60 | 1.5 |
| PRO + FLUOX | 60/60 | 1.1 |

All seeds, including controls, were treated with Acceleron 2013 (metalaxyl, ipconzole, clothiandin, and trifloxystrobin) commercial seed treatment (disease control+insect control) as base. N=3 locations.

Yield was determined in the following manner. The center two rows of the plot were harvested or both rows if it was a two row plot. The weight and percent moisture were recorded for each plot grain sample. The recorded plot weight and % moisture were converted to standardized weight using standard moisture of 15.5%. Each plot was normalized to kg/ha by interpolating plot yield area to hectares. Yield in bushels/acre (bu/A) was determined by interpolating plot yield area to acre and conversion to bu/A using a standard corn bushel weight of 56 lb.

TABLE 3
Yield Response with Seed Treatments in Inoculated Soil Plots

| | | Yield |
|---|---|---|
| Treatment* | Rate g/100 Kg seed | bu/A |
| Control | NA | 164.4 |
| Fluoxastrobin | 30 | 169.4 |
| | 60 | 172 |
| | 90 | 171.8 |
| Prothioconazole | 30 | 172.4 |
| | 60 | 173.6 |
| | 90 | 174 |
| Prothioconazole/Fluoxastrobin | 30/30 | 169.8 |
| Prothioconazole/Fluoxastrobin | 60/60 | 170 |
| Prothioconazole/Fluoxastrobin | 30/90 | 171.8 |
| Prothioconazole/Fluoxastrobin | 90/30 | 169 |

All seeds, including control, were treated with Acceleron 2013 commercial seed treatment (disease control+insect control) as a base. N=10 locations.

TABLE 4
Yield Response with Seed Treatments in Non-Inoculated Soil Plots

| | | Yield Trial 1 |
|---|---|---|
| Treatment* | Rate g/100 Kg seed | Bu/acre |
| Control | NA | 174.9 |
| Fluoxastrobin | 30 | 175.9 |
| | 60 | 179.1 |
| | 90 | not tested |
| Control | NA | 174.9 |
| Prothioconazole | 30 | 177.1 |
| | 60 | 178.6 |
| | 90 | not tested |
| Control | NA | 174.9 |
| Prothioconazole/Fluoxastrobin | 30/30 | 176.9 |
| Prothioconazole/Fluoxastrobin | 60/60 | 178.4 |

All seeds, including control, were treated with Acceleron 2013 commercial seed treatment (disease+insect control) as a base. N=22 locations.

TABLE 5
Yield Response with Seed Treatments in Non-Inoculated Soil Plots

| | | Yield Trial 2 |
|---|---|---|
| Treatment* | Rate g/100 Kg seed | Bu/acre |
| Control | NA | 174.4 |
| Fluoxastrobin | 30 | 175.9 |
| | 60 | 177.6 |
| | 90 | 176.3 |
| Prothioconazole | 30 | 176.6 |
| | 60 | 178.3 |
| | 90 | 175.2 |
| Prothioconazole/Fluoxastrobin | 30/30 | 180.2 |
| Prothioconazole/Fluoxastrobin | 60/60 | 179.3 |

All seeds, including control, were treated with Acceleron 2013 commercial seed treatment (disease+insect control) as a base. N=24 locations.

### Example 3

The seed tested (Amadeo harvest 2008, TKW 331,3) was seeded in trays 20×20×6 cm, with 9 holes for water release in field soil/quartz sand mix (1:1). Two repetitions with 25 kernels each were treated using standard seed treatment techniques. Each tray contained a single isolate of either Fusarium verticillioides G679, Fusarium verticillioides S039/07, Fusarium verticillioides S149/08, Colletotrichum graminicola BF0911 or Colletotrichum graminicola CG-1. The fungi were grown on sterile wheat grains. Thereafter, wheat grains were roughly ground after incubation and dried. For inoculation, either 5 or 15 ml of inoculum were scattered between the seeds at sowing, followed by incubation for 7 days at 10° C., followed by 7 days 24° C./15° C. (day/night period). Plants were evaluated for a) initial emergence (number of plants), b) final emergence (number of plants), c) disease level. Seedlings were classified in 3 categories: low, moderate or sevre necrosis. The disease score was calculated as follows:

$$\frac{\begin{matrix}[ ( shoots - low necroses ) + 2 x ( shoots - moderate necroses ) + \\ 3 x ( shoots - severe necroses ) + 4 x ( reduced emergence ) ] \times 100\end{matrix}}{( emergence in untreated not inoculated ) \times 4}$$

### Seed Safety

There was no delay of emergence observed in any of the five trials.

TABLE 6
Efficacy against Fusarium verticillioides (av. of 3 isolates)
Untreated (% damage) was 26%.

| | | | Efficacy (% Abbott) |
|---|---|---|---|
| Prothioconzaloe | FS100 | 30 g ai/100 kg seeds | 47 |
| Fluoxastrobin | FS100 | 30 g ai/100 kg seeds | 3 |

TABLE 7
Efficacy against Colletotrichum graminicola (av. 2 isolates)
Untreated (% damage) was 22%.

| | | | Efficacy (% Abbott) |
|---|---|---|---|
| Prothioconzaloe | FS100 | 30 g ai/100 kg seeds | 51 |
| Fluozastrobin | FS100 | 30 g ai/100 kg seeds | 88 |

### Example 4

The seeds (Trainer, harvest 2007, TKW 301,2) were treated using standard seed treatment techniques and seeded in a pot (9 cm diameter) in a soil sand mixture. The pots were kept for 7 days at 10° C. and after that placed in a greenhouse at 24/20° C. until the final evaluation. For inoculation, the autoclaved straw was mixed with a spore suspension (1 liter of suspension containing 8.25×10⁶ spores/ml per 2,5 kg of straw) and 50 ml of this mixture was placed at the base of the stem of each corn plant. Before inoculation a 5 mm long wound was caused with a needle at the stem base. During the trial the straw was kept humid. For the final evaluation, the plants were washed free from soil and the infection on the stem base and the lower leaves was measured using the following rating sheme:
Count and record number of nodes from inoculation point that show infection (rating 1-5)
Count and record number of nodes with |75% of length showing necrosis (rating 1-5)
Add the two values to get the final rating
Efficacy calculated by formula of Abbott

### Seed Safety

There was no delay of emergence observed in any of the five trials.

TABLE 8
Rating in uninoculated control
The Strain CG1origin was from Monsanto, St. Louis, USA.
The incoculation was done 26 days after planting. The first
evaluation was 48 days after seedling or 22 days after inoculation.
Rating in uninoculated control: 3

| Active ingredient (a.i.) | a.i. g/100 kg seeds | Efficacy (% abb) |
|---|---|---|
| Prothioconazole | 30 | 0 |
| Prothioconazole | 60 | 6 |
| Prothioconazole | 120 | 17 |
| Fluoxastrobin | 30 | 11 |
| Fluoxastrobin | 60 | 22 |
| Fluoxastrobin | 120 | 11 |
| Prothioconazole + Fluoxastrobin | 30 + 30 | 0 |
| Prothioconazole + Fluoxastrobin | 60 + 60 | 17 |
| Prothioconazole + Fluoxastrobin | 120 + 120 | 28 |

TABLE 9
Rating in untreated inoculated control
The Strain BF0911 origin was from Illinois, USA. The incoculation
was done 26 days after planting. The first evaluation was 48 days
after seedling or 22 days after inoculation.
Rating in untreated inoculated control: 3

| Active ingredient (a.i.) | a.i. g/100 kg seeds | Efficacy (% abb) |
|---|---|---|
| Prothioconazole | 30 | 0 |
| Prothioconazole | 60 | 0 |
| Prothioconazole | 120 | 20 |
| Fluoxastrobin | 30 | 0 |
| Fluoxastrobin | 60 | 0 |
| Fluoxastrobin | 120 | 30 |
| Prothioconazole + Fluoxastrobin | 30 + 30 | 5 |
| Prothioconazole + Fluoxastrobin | 60 + 60 | 30 |
| Prothioconazole + Fluoxastrobin | 120 + 120 | 30 |

### EMBODIMENTS

For further illustration, additional non-limiting embodiments of the present disclosure are set forth below.

For example, embodiment 1 is a method of controlling stalk rot in corn, the method comprising administering prothioconazole and fluoxastrobin to one or more corn seeds,

wherein the application rate of prothioconazole is at least about 10 grams a.i. per 100 kilograms of seed,

and wherein the application rate of fluoxastrobin is at least about 10 grams a.i. per 100 kilograms of seed.

Embodiment 2 is a method of controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, the method comprising administering prothioconazole and fluoxastrobin to one or more corn seeds,

wherein the application rate of prothioconazole is at least about 10 grams a.i. per 100 kilograms of seed,

and wherein the application rate of fluoxastrobin is at least about 10 grams a.i. per 100 kilograms of seed.

Embodiment 3 is a method of improving one or more agronomic characteristics of corn selected from the group consisting of plant stand, crop safety, stalk lodging and plant vigor, the method comprising administering prothioconazole and fluoxastrobin to one or more corn seeds,

wherein the application rate of prothioconazole is at least about 10 grams a.i. per 100 kilograms of seed,

and wherein the application rate of fluoxastrobin is at least about 10 grams a.i. per 100 kilograms of seed.

Embodiment 4 is a method of improving yield, the method comprising administering prothioconazole to one or more corn seeds,

wherein the application rate of prothioconazole is at least about 10 grams a.i. per 100 kilograms of seed.

Embodiment 5 is a method of improving yield, the method comprising administering fluoxastrobin to one or more corn seeds,

wherein the application rate of fluoxastrobin is at least about 10 grams a.i. per 100 kilograms of seed.

Embodiment 6 is a method of improving yield, the method comprising administering fluoxastrobin and prothiconazole to one or more corn seeds,

wherein the application rate of prothioconazole is at least about 10 grams a.i. per 100 kilograms of seed; and

wherein the application rate of fluoxastrobin is at least about 10 grams a.i. per 100 kilograms of seed.

Embodiment 7 is the method of embodiment 3 wherein the method improves the plant stand of corn plants grown from the corn seeds.

Embodiment 8 is the method of embodiment 3 wherein the method improves the vigor of corn plants grown from the corn seeds.

Embodiment 9 is the method of embodiment 3 wherein the method improves the crop safety of corn plants grown from the corn seeds.

Embodiment 10 is the method of any one of embodiments 1 to 9 wherein the corn seeds are transgenic corn seeds.

Embodiment 11 is the method of any one of embodiments 1 to 10 wherein the method comprises administering prothioconazole at a rate of at least about 15, 30, 45, 60, 75, or 90 grams a.i. per 100 kilograms of seed.

Embodiment 12 is the method of any one of embodiments 1 to 11 wherein the application rate of prothioconazole is from about 30 to about 90, from about 45 to about 75, or from about 50 to about 60 grams a.i. per 100 kilograms of seed.

Embodiment 13 is the method of any one of embodiments 1 to 12 wherein the method comprises administering fluoxastrobin at a rate of at least about 15, 30, 45, 60, 75, or 90 grams a.i. per 100 kilograms of seed.

Embodiment 14 is the method of any one of embodiments 1 to 13 wherein the application rate of fluoxastrobin is from about 30 to about 90, from about 45 to about 75, or from about 50 to about 60 grams a.i. per 100 kilograms of seed.

Embodiment 15 is the method of any one of embodiments 1 to 14 wherein the combined application rate of prothioconazole and fluoxastrobin is at least about 30, 60, 90, 120, 150, or 180 grams a.i. per 100 kilograms of seed.

Embodiment 16 is the method of any one of embodiments 1 to 15 wherein the combined application rate of prothioconazole and fluoxastrobin is from about 20 to about 180, from about 30 to about 180, from about 60 to about 180, from about 90 to about 150, or from about 110 to about 130 grams a.i. per 100 kilograms of seed.

Embodiment 17 is a method of controlling stalk rot in corn, the method comprising administering prothioconazole and fluoxastrobin to soil surrounding a corn seed, or to soil surrounding the root zone of a corn plant, wherein the application rate of prothioconazole is at least about 50 grams a.i. per acre, and wherein the application rate of fluoxastrobin is at least about 50 grams a.i. per acre.

Embodiment 18 is a method of controlling one or more fungal pathogens selected from the group consisting of Sclerotinia, Colletotrichum, Diplodia/Stenocarpella, Fusarium, Gibberella, Macrophomina, and Marasmiellus, Physoderma, and Harpophora in corn, the method comprising administering prothioconazole and fluoxastrobin to soil surrounding a corn seed, or to soil surrounding the root zone of a corn plant, wherein the application rate of prothioconazole is at least about 50 grams a.i. per acre, and wherein the application rate of fluoxastrobin is at least about 50 grams a.i. per acre.

Embodiment 19 is a method of improving one or more agronomic characteristics of corn selected from the group consisting of plant stand, crop safety, stalk lodging and plant vigor, the method comprising administering prothioconazole and fluoxastrobin to soil surrounding a corn seed, or to soil surrounding the root zone of a corn plant, wherein the application rate of prothioconazole is at least about 50 grams a.i. per acre, and wherein the application rate of fluoxastrobin is at least about 50 grams a.i. per acre.

Embodiment 20 is the method of any one of embodiments 17 to 19 comprising administering prothioconazole and fluoxastrobin to soil surrounding a corn seed.

Embodiment 21 is the method of any one of embodiments 17 to 19 wherein the prothioconazole and fluoxastrobin are administered to soil surrounding the root zone of a corn plant.

Embodiment 22 is the method of embodiment 20 or 21 wherein the prothioconazole and fluoxastrobin are administered using a drip irrigation technique.

Embodiment 23 is the method of embodiment 20 or 21 wherein the prothioconazole and fluoxastrobin are administered directly to the base of the plants or to the soil immediately adjacent to the plants.

Embodiment 24 is the method of embodiment 20 or 21 wherein the prothioconazole and fluoxastrobin are tilled into the soil or applied in furrow.

Embodiment 25 is the method of any one of embodiments 17 to 24 wherein the application rate of prothioconazole is at least about 60, 70, 80 or 90 grams a.i. per acre.

Embodiment 26 is the method of any one of embodiments 17 to 25 wherein the application rate of prothioconazole is from about 50 to about 100 grams a.i. per acre.

Embodiment 27 is the method of any one of embodiments 17 to 26 wherein the application rate of fluoxastrobin is at least about 60, 70, 80 or 90 grams a.i. per acre.

Embodiment 28 is the method of any one of embodiments 17 to 27 wherein the application rate of fluoxastrobin is from about 50 to about 100 grams a.i. per acre.

Embodiment 29 is the method of any one of embodiments 1 to 28 wherein the method is effective to control stalk, ear or root rot in corn caused by one or more fungal pathogens selected from the group consisting of Sclerotinia, Colletotrichum, Diplodia/Stenocarpella, Fusarium, Gibberella, Macrophomina, Marasmiellus, Physoderma, and Harpophora.

Embodiment 30 is the method of embodiment 29 wherein the method is effective to control stalk, ear or root rot in corn caused by one or more fungal pathogens selected from the group consisting of Sclerotinia sclerotiorum, Sclerotinia libertiani, Colletotrichum graminicola, Diplodia maydis, Stenocarpella maydis), Fusarium moniliforme, F. verticilliodes, Giberella zeae, G. saubinetti, Fusarium roseum f sp. Cerealis, F. roseum graminearum, F. graminearum, Macrophomina phaseolina Marasmiellus spp, Physoderma maydis, and Harpophora maydis.

Embodiment 31 is the method of embodiment 29 or 30 wherein the method is effective to control Gibberella or Fusarium stalk and ear rot.

Embodiment 32 is the method of embodiment 29 or 30 wherein the method is effective to control Anthracnose stalk rot.

Embodiment 33 is the method of embodiment 29 or 30 wherein the method is effective to control Marasmiellus stalk and root rot.

Embodiment 34 is the method of embodiment 29 or 30 wherein the method is effective to control Diplodia ear or stalk rot, Sclerotinia stalk rot or Macrophomina stalk rot.

Embodiment 35 is the method of embodiment 29 or 30 wherein the method is effective to control Physoderma brown spot.

Embodiment 36 is the method of embodiment 29 or 30 wherein the method is effective to control Harpophora late wilt.

Embodiment 37 is the method of any one of embodiments 1 to 36 wherein the prothioconazole and the fluoxastrobin are administered in a weight ratio of from about 3:1 to about 1:3.

Embodiment 38 is the method of embodiment 37 wherein the method comprises administering prothioconazole and the fluoxastrobin in a weight ratio of from about 2:1 to about 1:2, in a weight ratio of from about 1.5:1 to about 1:1.5, or in a weight ratio of about 1:1.

Embodiment 39 is the method of any one of embodiments 1 to 38 further comprising the administration of one or more additional fungicides selected from the group consisting of acibenzolar-S-methyl, azoxystrobin, benalaxyl, bixafen, boscalid, carbendazim, chlorothalonil, cyproconazole, dimethomorph, epoxiconazole, fludioxonil, fluopyram, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, pyraclostrobin, sedaxane, silthiofam, tebuconazole, thifluzamide, thiophanate, tolclofos-methyl, trifloxystrobin, and triticonazole.

Embodiment 40 is the method of embodiment 39 comprising the administration of one or more fungicides selected from the group consisting of silthiofam, azoxystrobin, sedaxane, fluopyram, ipconazole, mefenoxam, metalaxyl, trifloxystrobin, fluxapyroxad, and pyraclostrobin.

Embodiment 41 is the method of any one of embodiments 1 to 40 further comprising the administration of a biological agent, microbial extract, plant growth activator, plant defense agent, or a mixture thereof.

Embodiment 42 is the method of embodiment 41 comprising the administration of a biological agent selected from the group consisting of bacteria, fungi, beneficial nematodes, and viruses.

Embodiment 43 is the method of embodiment 42 comprising the administration of a biological agent comprising a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comomonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobium, Serratia, Sphingobacterium, Stenotrophomonas, Variovax, or Xenorhabdus.

Embodiment 44 is the method of embodiment 42 or 43 comprising the administration of a biological agent comprising a fungus of the genus Alternaria, Ampelomyces, Aspergillus, Aureobasidium, Beauveria, Colletotrichum, Coniothyrium, Gliocladium, Metarhisium, Muscodor, Paecilonyces, Trichoderma, Typhula, Ulocladium, or Verticilium.

Embodiment 45 is the method of any one of embodiments 41 to 43 comprising the administration of a biological agent comprising a plant growth activator or plant defense agent selected from the group consisting of harpin, Reynoutria sachalinensis, jasmonate, lipochitooligosaccharides, salicylic acid, and isoflavones.

Embodiment 46 is the method of any one of embodiments 1 to 45 further comprising the administration of an insecticide or nematicide selected from the group consisting of abamectin, aldicarb, aldoxycarb, bifenthrin, carbofuran, chlorantraniliprole, clothianidin, cyfluthrin, cyhalothrin, cyantraniliprole, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, tioxazafen, nitenpyram, oxamyl, permethrin, spinetoram, spinosad, spirodichlofen, spirotetramat, tefluthrin, thiacloprid, thiamethoxam, thiodicarb, and mixtures thereof.

Embodiment 47 is the method of any one of embodiments 1 to 46 further comprising the administration of an herbicide selected from the group consisting of acetochlor, clethodim, dicamba, flumioxazin, fomesafen, glyphosate, glufosinate, mesotrione, quizalofop, saflufenacil, sulcotrione, 2,4-D, and mixtures thereof.

Embodiment 48 is the method of any one of embodiments 1 to 47 further comprising the administration of an additional pesticide or biological agent selected from the group consisting of fluxapyroxad, ipconazole, metalaxyl, mefenoxam, sedaxane, fluopyram, penflufen, pyraclostrobin, trifloxystrobin, abamectin, Bacillus firmus, clothianidin, imidacloprid, thiamethoxam, tioxazafen and mixtures thereof.

Embodiment 49 is a treated corn seed comprising prothioconazole and fluoxastrobin,

wherein the seed comprises prothioconazole in a concentration of at least about 10 grams a.i. per 100 kilograms of seed,

and wherein the seed comprises fluoxastrobin is a concentration of at least about 10 grams a.i. per 100 kilograms of seed.

Embodiment 50 is the treated seed of embodiment 49 wherein the corn seed is a transgenic corn seed.

Embodiment 51 is the treated seed of embodiment 49 or 50 wherein a corn plant grown from the seed exhibits increased resistance to stalk, ear or root rot.

Embodiment 52 is the treated seed of embodiment 49 or 50 wherein a corn plant grown from the seed exhibits improved resistance to disease caused by one or more fungal pathogens selected from the group consisting of Sclerotinia, Colletotrichum, Diplodia/Stenocarpella, Fusarium, Gibberella, Macrophomina, Marasmiellus, Physoderma, and Harpophora.

Embodiment 53 is the treated seed of embodiment 49 or 50 wherein a corn plant grown from the seed exhibits improved resistance to stalk, ear or root rot caused by one or more fungal pathogens selected from the group consisting of Sclerotinia, Colletotrichum, Diplodia/Stenocarpella, Fusarium, Gibberella, Macrophomina, Marasmiellus, Physoderma and Harpophora.

Embodiment 54 is the treated seed of embodiment 53 wherein a corn plant grown from the seed exhibits improved resistance to stalk, ear or root rot caused by one or more fungal pathogens selected from the group consisting of Sclerotinia sclerotiorum, Sclerotinia libertiani, Colletotrichum graminicola, Diplodia maydis, Stenocarpella maydis), Fusarium moniliforme, F. verticilliodes, Giberella zeae, G. saubinetti, Fusarium roseum f sp. Cerealis, F. roseum graminearum, F. graminearum, Macrophomina phaseolina Marasmiellus spp., Physoderma maydis, and Harpophora maydis.

Embodiment 55 is the treated seed of embodiment 53 or 54 wherein the method is effective to control Gibberella or Fusarium stalk and ear rot.

Embodiment 56 is the treated seed of embodiment 53 or 54 wherein the method is effective to control Anthracnose stalk rot.

Embodiment 57 is the treated seed of embodiment 53 or 54 wherein the method is effective to control Marasmiellus stalk and root rot.

Embodiment 58 is the treated seed of embodiment 53 or 54 wherein the method is effective to control Diplodia ear or stalk rot, Sclerotinia stalk rot or Macrophomina stalk rot.

Embodiment 59 is the treated seed of any one of embodiments 49 to 58 wherein a corn plant grown from the seed exhibits one or more improved agronomic characteristics of corn selected from the group consisting of plant stand, crop safety and plant vigor or increased yield.

Embodiment 60 is the treated seed of embodiment 59 wherein a corn plant grown from the seed exhibits improved yield.

Embodiment 61 is the treated seed of embodiment 59 wherein a corn plant grown from the seed exhibits improved plant stand.

Embodiment 62 is the treated seed of embodiment 59 wherein a corn plant grown from the seed exhibits improved vigor.

Embodiment 63 is the treated seed of any one of embodiments 49 to 62 wherein the seed comprises prothioconazole in a concentration of at least about 15, 30, 45, 60, 75, or 90 grams a.i. per 100 kilograms of seed.

Embodiment 64 is the treated seed of any one of embodiments 49 to 63 wherein the seed comprises prothioconazole in a concentration of from about 30 to about 90, from about 45 to about 75, or from about 50 to about 60 grams a.i. per 100 kilograms of seed.

Embodiment 65 is the treated seed of any one of embodiments 49 to 64 wherein the seed comprises fluoxastrobin in a concentration of at least about 15, 30, 45, 60, 75, or 90 grams a.i. per 100 kilograms of seed.

Embodiment 66 is the treated seed of any one of embodiments 49 to 65 wherein the seed comprises fluoxastrobin in a concentration of from about 30 to about 90, from about 45 to about 75, or from about 50 to about 60 grams a.i. per 100 kilograms of seed.

Embodiment 67 is the treated seed of any one of embodiments 49 to 66 wherein the seed comprises prothioconazole and fluoxastrobin in a combined concentration of at least about 30, 60, 90, 120, 150, or 180 grams a.i. per 100 kilograms of seed.

Embodiment 68 is the treated seed of any one of embodiments 49 to 67 wherein the seed comprises prothioconazole and fluoxastrobin in a combined concentration of from about 20 to about 180, from about 30 to about 180, from about 60 to about 180, from about 90 to about 150, or from about 110 to about 130 grams a.i. per 100 kilograms of seed.

Embodiment 69 is the treated seed of any one of embodiments 49 to 67 wherein the seed comprises prothioconazole and the fluoxastrobin in a weight ratio of from about 3:1 to about 1:3.

Embodiment 70 is the treated seed of embodiment 69 wherein the seed comprises prothioconazole and the fluoxastrobin in a weight ratio of from about 2:1 to about 1:2, in a weight ratio of from about 1.5:1 to about 1:1.5, or in a weight ratio of about 1:1.

Embodiment 71 is the treated seed of any one of embodiments 49 to 70 further comprising one or more additional fungicides selected from the group consisting of acibenzolar-S-methyl, azoxystrobin, benalaxyl, bixafen, boscalid, carbendazim, chlorothalonil, cyproconazole, dimethomorph, epoxiconazole, fludioxonil, fluopyram, flutianil, flutolanil, fluxapyroxad, fosetyl-Al, ipconazole, isopyrazam, kresoxim-methyl, mefenoxam, metalaxyl, metconazole, myclobutanil, orysastrobin, penflufen, penthiopyrad, picoxystrobin, propiconazole, pyraclostrobin, sedaxane, silthiofam, tebuconazole, thifluzamide, thiophanate, tolclofos-methyl, trifloxystrobin, and triticonazole.

Embodiment 72 is the treated seed of embodiment 71 comprising the administration of one or more fungicides selected from the group consisting of silthiofam, azoxystrobin, ipconazole, sedaxane, fluopyram, mefenoxam, metalaxyl, trifloxystrobin, fluxapyroxad, and pyraclostrobin.

Embodiment 73 is the treated seed of any one of embodiments 49 to 72 further comprising a biological agent, microbial extract, plant growth activator, plant defense agent, or a mixture thereof.

Embodiment 74 is the treated seed of embodiment 73 further comprising a biological agent selected from the group consisting of bacteria, fungi, beneficial nematodes, and viruses.

Embodiment 75 is the treated seed of embodiment 74 further comprising a biological agent comprising a bacterium of the genus Actinomycetes, Agrobacterium, Arthrobacter, Alcaligenes, Aureobacterium, Azobacter, Bacillus, Beijerinckia, Brevibacillus, Burkholderia, Chromobacterium, Clostridium, Clavibacter, Comomonas, Corynebacterium, Curtobacterium, Enterobacter, Flavobacterium, Gluconobacter, Hydrogenophaga, Klebsiella, Methylobacterium, Paenibacillus, Pasteuria, Photorhabdus, Phyllobacterium, Pseudomonas, Rhizobium, Serratia, Sphingobacterium, Stenotrophomonas, Variovax, or Xenorhabdus.

Embodiment 76 is the treated seed of embodiment 73 or 74 further comprising a biological agent comprising a fungus of the genus Alternaria, Ampelomyces, Aspergillus, Aureobasidium, Beauveria, Colletotrichum, Coniothyrium, Gliocladium, Metarhisium, Muscodor, Paecilonyces, Trichoderma, Typhula, Ulocladium, or Verticilium.

Embodiment 77 is the treated seed of any one of embodiments 73 to 76 further comprising a biological agent comprising a plant growth activator or plant defense agent selected from the group consisting of harpin, Reynoutria sachalinensis, jasmonate, lipochitooligosaccharides, salicylic acid and isoflavones.

Embodiment 78 is the treated seed of any one of embodiments 49 to 77 further comprising an insecticide or nematicide selected from the group consisting of abamectin, aldicarb, aldoxycarb, bifenthrin, carbofuran, chlorantraniliprole, clothianidin, cyantraniliprole, cyfluthrin, cyhalothrin, cypermethrin, deltamethrin, dinotefuran, emamectin, ethiprole, fenamiphos, fipronil, flubendiamide, fosthiazate, imidacloprid, ivermectin, lambda-cyhalothrin, milbemectin, tioxazafen, nitenpyram, oxamyl, permethrin, spinetoram, spinosad, spirodichlofen, spirotetramat, tefluthrin, thiacloprid, thiamethoxam, thiodicarb, and mixtures thereof.

Embodiment 79 is the treated seed of any one of embodiments 49 to 78 further comprising an insecticide selected from the group consisting of clothianidin, imidacloprid, thiamethoxam and mixtures thereof.

Embodiment 80 is the treated seed of any one of embodiments 49 to 79 further comprising an herbicide selected from the group consisting of acetochlor, clethodim, dicamba, flumioxazin, fomesafen, glyphosate, glufosinate, mesotrione, quizalofop, saflufenacil, sulcotrione, 2,4-D, and mixtures thereof.

Embodiment 81 is the treated seed of any one of embodiments 49 to 80 further comprising an additional pesticide selected from the group consisting of fluxapyroxad, ipconazole, metalaxyl, penflufen, pyraclostrobin, trifloxystrobin, abamectin, Bacillus firmus, clothianidin, imidacloprid, thiamethoxam, and mixtures thereof.

Embodiment 82 is a composition for (i) controlling stalk rot in corn, (ii) controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, (iii) improving one or more agronomic characteristics of corn selected from the group consisting of plant stand, crop safety, stalk lodging and plant vigor or (iv) improving yield, the composition comprising prothioconazole and fluoxastrobin,

wherein the application rate of prothioconazole is at least about 10 grams a.i. per 100 kilograms of seed,

and wherein the application rate of fluoxastrobin is at least about 10 grams a.i. per 100 kilograms of seed.

When introducing elements herein, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description shall be interpreted as illustrative and not in a limiting sense.

What is claimed is:

1. A method of controlling stalk rot in corn, the method comprising administering prothioconazole and fluoxastrobin to one or more corn seeds,
wherein the application rate of prothioconazole is at least about 10 grams a.i. per 100 kilograms of seed,
and wherein the application rate of fluoxastrobin is at least about 10 grams a.i. per 100 kilograms of seed.

2. A method of controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, the method comprising administering prothioconazole and fluoxastrobin to one or more corn seeds,
wherein the application rate of prothioconazole is at least about 10 grams a.i. per 100 kilograms of seed,
and wherein the application rate of fluoxastrobin is at least about 10 grams a.i. per 100 kilograms of seed.

3. A method of improving one or more agronomic characteristics of corn selected from the group consisting of plant stand, crop safety, stalk lodging and plant vigor, the method comprising administering prothioconazole and fluoxastrobin to one or more corn seeds,
wherein the application rate of prothioconazole is at least about 10 grams a.i. per 100 kilograms of seed,
and wherein the application rate of fluoxastrobin is at least about 10 grams a.i. per 100 kilograms of seed.

4. A method of improving yield, the method comprising administering prothioconazole to one or more corn seeds,
wherein the application rate of prothioconazole is at least about 10 grams a.i. per 100 kilograms of seed.

5. A method of improving yield, the method comprising administering fluoxastrobin to one or more corn seeds,
wherein the application rate of fluoxastrobin is at least about 10 grams a.i. per 100 kilograms of seed.

6. A method of improving yield, the method comprising administering fluoxastrobin and prothiconazole to one or more corn seeds,
wherein the application rate of prothioconazole is at least about 10 grams a.i. per 100 kilograms of seed; and
wherein the application rate of fluoxastrobin is at least about 10 grams a.i. per 100 kilograms of seed.

7. The method of any one of claims 1 to 6 wherein the corn seeds are transgenic corn seeds.

8. The method of any one of claims 1 to 7 wherein the method comprises administering prothioconazole at a rate of at least about 15, 30, 45, 60, 75, or 90 grams a.i. per 100 kilograms of seed.

9. The method of any one of claims 1 to 8 wherein the application rate of prothioconazole is from about 30 to about 90, from about 45 to about 75, or from about 50 to about 60 grams a.i. per 100 kilograms of seed.

10. The method of any one of claims 1 to 9 wherein the method comprises administering fluoxastrobin at a rate of at least about 15, 30, 45, 60, 75, or 90 grams a.i. per 100 kilograms of seed.

11. The method of any one of claims 1 to 10 wherein the application rate of fluoxastrobin is from about 30 to about 90, from about 45 to about 75, or from about 50 to about 60 grams a.i. per 100 kilograms of seed.

12. The method of any one of claims 1 to 11 wherein the combined application rate of prothioconazole and fluoxastrobin is at least about 30, 60, 90, 120, 150, or 180 grams a.i. per 100 kilograms of seed.

13. The method of any one of claims 1 to 12 wherein the combined application rate of prothioconazole and fluoxastrobin is from about 20 to about 180, from about 30 to about 180, from about 60 to about 180, from about 90 to about 150, or from about 110 to about 130 grams a.i. per 100 kilograms of seed.

14. A method of controlling stalk rot in corn, the method comprising administering prothioconazole and fluoxastrobin to soil surrounding a corn seed, or to soil surrounding the root zone of a corn plant,
wherein the application rate of prothioconazole is at least about 50 grams a.i. per acre,
and wherein the application rate of fluoxastrobin is at least about 50 grams a.i. per acre.

15. A method of controlling one or more fungal pathogens selected from the group consisting of Sclerotinia, Colletotrichum, Diplodia/Stenocarpella, Fusarium, Gibberella, Macrophomina, and Marasmiellus, Physoderma, and Harpophora in corn, the method comprising administering prothioconazole and fluoxastrobin to soil surrounding a corn seed, or to soil surrounding the root zone of a corn plant,
wherein the application rate of prothioconazole is at least about 50 grams a.i. per acre,
and wherein the application rate of fluoxastrobin is at least about 50 grams a.i. per acre.

16. A method of improving one or more agronomic characteristics of corn selected from the group consisting of plant stand, crop safety, stalk lodging and plant vigor, the method comprising administering prothioconazole and fluoxastrobin to soil surrounding a corn seed, or to soil surrounding the root zone of a corn plant,
wherein the application rate of prothioconazole is at least about 50 grams a.i. per acre,
and wherein the application rate of fluoxastrobin is at least about 50 grams a.i. per acre.

17. The method of any one of claims 14 to 16 wherein the application rate of prothioconazole is at least about 60, 70, 80 or 90 grams a.i. per acre.

18. The method of any one of claims 14 to 17 wherein the application rate of prothioconazole is from about 50 to about 100 grams a.i. per acre.

19. The method of any one of claims 14 to 18 wherein the application rate of fluoxastrobin is at least about 60, 70, 80 or 90 grams a.i. per acre.

20. The method of any one of claims 14 to 19 wherein the application rate of fluoxastrobin is from about 50 to about 100 grams a.i. per acre.

21. A treated corn seed comprising prothioconazole and fluoxastrobin,
wherein the seed comprises prothioconazole in a concentration of at least about 10 grams a.i. per 100 kilograms of seed,
and wherein the seed comprises fluoxastrobin is a concentration of at least about 10 grams a.i. per 100 kilograms of seed.

22. A composition for (i) controlling stalk rot in corn, (ii) controlling one or more fungal pathogens selected from the group consisting of Sclerotinia, Colletotrichum, Diplodia/Stenocarpella, Fusarium, Gibberella, Macrophomina, Marasmiellus, Physoderma and Harpophora in corn, (iii) improving one or more agronomic characteristics of corn selected from the group consisting of plant stand, crop safety, stalk lodging and plant vigor or (iv) improving yield, the composition comprising prothioconazole and fluoxastrobin,
wherein the application rate of prothioconazole is at least about 10 grams a.i. per 100 kilograms of seed,
and wherein the application rate of fluoxastrobin is at least about 10 grams a.i. per 100 kilograms of seed.
